(19) United States
(12) Patent Application Publication
(10) Pub. No.: US 2009/0080390 A1
(43) Pub. Date: Mar. 26, 2009

(54) Method of Discovering Devices Located in Different Wireless Networks

(75) Inventors: Xiaoyu Zhou, Beijing (CN); Jingnan Huang, Beijing (CN); Yujin Luo, Beijing (CN)

Correspondence Address: KINNEY & LANGE, P.A., THE KINNEY & LANGE BUILDING, 312 SOUTH THIRD STREET, MINNEAPOLIS, MN, 55415-1002, US

(73) Assignees: Beijing Lenove Software Ltd. Shangdi Information Industry Base Haidian District, Beijing (CN); Lenovo (Beijing) Limited Shangdi Information Industry Base Haidan District, Beijing (CN)

(21) Appl. No.: 11/886,598

(22) PCT Filed: Dec. 8, 2005
(86) PCT No.: PCT/CN2005/002128

§ 371 Date: Sep. 18, 2007

(30) Foreign Application Priority Data
Mar. 18, 2005 (CN) 200510055500.6

(51) Int. Cl. H04W 84/02

(52) U.S. Cl. 370/338

(57) ABSTRACT

The invention discloses a method of discovering devices located in different wireless networks, a wireless network being built up for a device, wherein network is identified with a wireless network identification (Service Set Identification (SSID)) having an array for identifying device types, a correspondence between the array for identifying the device types and the device types being arranged at a user terminal, the method comprising steps of: A. searching for a currently available wireless network by the user terminal in a wireless network environment in order to obtain an SSID corresponding to the currently available wireless network; B. determining a device type corresponding to an array owned by the obtained SSID according to the arranged correspondence, and displaying a device icon for the device type corresponding to the SSID, by the user terminal. The method enables the user terminal to discover a device located in a wireless network different from the user terminal rapidly and conveniently.

### BACKGROUND OF THE INVENTION

1. Field of Invention

The present invention relates to a technique for discovering devices located in computer networks, particularly to a method of discovering devices located in different computer networks.

2. Description of Prior Art

With the increasingly development of computer techniques and network techniques, a computer network is gradually getting into our daily works and lives. In the environment of office and home, various devices are connected to each other via the computer network, which enables the usage of these various devices more conveniently.

When a user terminal uses a device via the computer network, it has to discover the device first so as to find out related information on the device such as device type etc. For example, when the user terminal needs to use a projector, only if it has to find a device whose type is a projector located in the computer network first, the device may be used to complete the projecting operation.

Currently, there are three methods to discover a device via a computer network:

The first one: Information on various devices located in the computer network is stored in one server. When a new device accesses the computer network, it registers its device information with the server located in the computer network. When the user terminal needs to use the device, it accesses the server via the computer network, obtains the device information stored in the server and searched for the device to be used.

The second one: Announcement message containing self-related information is broadcasted in the computer network by various devices located in the computer network. When the user terminal needs to use the device, it listens to the announcement message broadcasted in the computer network in which the device to be used is located, and searches for the device to be used.

The third one: When the user terminal needs to use the device, it broadcasts a message on searching for device information in the computer network and waits for the device which receives the broadcast and complies with the device information searched for to respond to the user terminal.

With any one of the above methods, the device to be used by the user terminal may be discovered in the same computer network as the user terminal. However, when the device to be discovered is located in a computer network different from the user terminal, the user terminal has to switch to the computer network in which the device is located, and then the device may be discovered by one of the above methods.

Accordingly, when the computer network is a wireless computer network, the user terminal may find the wireless computer network corresponding to SSID by searching for SSID in the wireless environment, although each of wireless computer networks is identified with a wireless network identification (SSID (Service Set IDentification)). However, when the user terminal searches for the device located in the computer network different from the user terminal, it also has to access this wireless computer network according to SSID corresponding to the wireless computer network and then searches for the device accessing the network. For example, when the user terminal needs to use a wireless projector, it finds several available wireless computer networks. Only if it switches to these available wireless computer networks and uses one of the above methods, it would learn whether there is such a wireless projector in these available computer networks. Thus, not only the rate at which the user terminal discovers the device is reduced, but also the complexity of the device discovered by the user terminal is increased.

### SUMMARY OF THE INVENTION

Accordingly, a main object of the present invention is to provide a method of discovering devices located in different wireless computer networks, which enables a user terminal to discover a device located in a wireless computer network different from the user terminal rapidly and conveniently.

According to the object as described above, the technical scheme of the present invention is implemented as follows:

A method of discovering devices located in different wireless computer networks, a wireless computer network being built up for a device, wherein the wireless computer network is identified with an SSID having an array for identifying device types, a correspondence between the array for identifying the device types and the device types being arranged at a user terminal, the method comprising steps of:

A. searching for a currently available wireless computer network by the user terminal in a wireless computer network environment in order to obtain an SSID corresponding to the currently available wireless computer network;

B. determining a device type corresponding to an array owned by the obtained SSID according to the arranged correspondence, and displaying a device icon for the device type corresponding to the SSID, by the user terminal.

when the user terminal discovers a device of the determined type, the step B of determining a device type corresponding to an array owned by the obtained SSID according to the arranged correspondence comprises steps of:

B1. the user terminal determining an array corresponding to a type of the device to be discovered according to the arranged correspondence; judging whether the array corresponding to the type of the device to be discovered matches at least one of SSIDs obtained in the step A or not; and in a case of matching, determining that there is a device of the determined type to be discovered by the user terminal in the wireless computer network corresponding to the matched SSID.

The array may be a numeric string, a character string or a combination thereof.

The SSID further comprises an array used for identifying devices.

It can been seen from the above schemes that a wireless computer network is built up for a wireless device according to the present invention, wherein the network is identified with SSID having an array for identifying device types; a correspondence between the array for identifying the device types and the device types is arranged at the user terminal. The user terminal learns the type of the device located in the wireless computer network corresponding to the SSID by means of searching for SSID in the wireless environment. Therefore, the method according to the present invention may enable the user terminal to discover a device located in a wireless computer network different from the user terminal rapidly and conveniently.

### BRIEF DESCRIPTION OF THE DRAWINGS

FIG. 1 is a flowchart for discovering a device rapidly by using an SSID according to the present invention; and

FIG. 2 is a network schematic view of an embodiment for discovering a device rapidly by using an SSID according to the present invention.

### DETAILED DESCRIPTION OF PREFERRED EMBODIMENTS

Hereinafter, the present invention will be further described in detail by referring to the drawings and the embodiments in order to make the objects, technical scheme and advantages of the present invention more apparent.

The present invention rearranges SSID so that the rearranged SSID is not only used for identifying a wireless computer network, but also for identifying a wireless device located in the wireless computer network. According to the SSID, a user terminal may determine the wireless device existed in the wireless computer network corresponding to the SSID.

The present invention establishes a peer-to-peer wireless computer network, and identifies the peer-to-peer wireless computer network established by the wireless device with an SSID. According to the present invention, the SSID is arranged, and a denomination specification on SSID is defined: a first part of arrays in SSID represent a device type, for example, a prefix in SSID represents the device type so that device types in the wireless computer network are obtained according to the part of arrays in SSID; a second part of arrays in SSID represent different devices of same device type, for example, several bits following the prefix in SSID represent different devices of same device type so that devices located in the wireless computer network are obtained according to the second part of arrays in SSID. Thus, the arranged SSID according to the present invention is not only used for identifying a wireless computer network, but also for identifying a device located in the wireless computer network.

The array according to the present invention may be a numeric string, a character string or a combination thereof.

The first part of arrays and the second part of arrays according to the present invention don't represent the detailed positions in SSID where various arrays are located. According to the present invention, the second part of arrays may be located in the head of SSID, which only represents that the SSID would have the two parts.

Accordingly, the correspondence between arrays and device types is arranged at the user terminal in order to enable the user terminal to identify the device type represented with SSID. The correspondence between arrays and device types arranged at the user terminal should be the same as the correspondence between arrays and device types represented in SSID.

When the user terminal is searching for the wireless computer network, he may query an SSID corresponding to the wireless computer network. The device type corresponding to the array in SSID searched is determined according to the correspondence arranged at the user terminal, the wireless computer network corresponding to the SSID is proved to have a device of this device type, and this is device type is displayed. When the user terminal needs to use the device of this device type, it may access this wireless computer network.

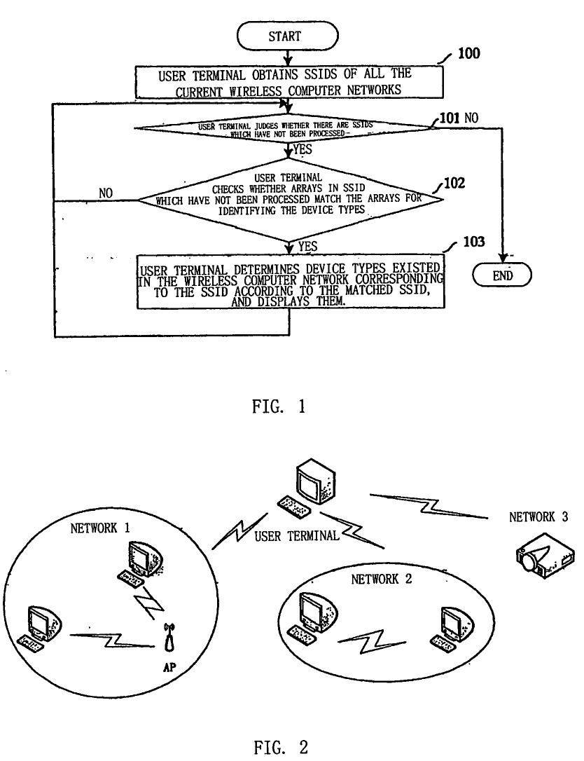

FIG. 1 is a flowchart for discovering a device rapidly by using an SSID according to the present invention, which comprises the following steps:

step 100, wherein the user terminal searches for the current wireless computer networks, and obtains SSIDs of all the wireless computer networks;

step 101, wherein the user terminal judges whether there are SSIDs which have not been processed; if so, step 102 is performed; otherwise, the process is ended;

step 102, wherein the user terminal checks whether arrays in SSID which have not been processed match the arrays for identifying the device types; if so, step 103 is performed; otherwise, step 101 is performed;

step 103, wherein the user terminal determines device types existed in the wireless computer network corresponding to the SSID according to the matched SSID and displays them; then returns to step 101.

When the user terminal is installing a device driver, it may obtain the array for identifying the device type of this device. It is possible to make the array corresponding to the device type of this device.

The present invention will be explained in detail by taking a wireless projector as an example.

The wireless projector establishes the wireless computer network and arranges its SSID as an array corresponding to a type of wireless projector. The user terminal may find a wireless computer network corresponding to the SSID including the array representing the wireless projector in order to discover that there exists a wireless projector in some wireless computer network. When the user terminal discovers the wireless computer network to which the wireless projector belongs, it is not necessary to switch to the wireless computer network. Only if the wireless projector is to be used, the user terminal switches to the wireless computer network.

Therefore, the whole processing for the user terminal discovering the wireless projector are as follows:

First, the SSID corresponding to the wireless computer network where the wireless projector is located is arranged; assuming that the SSID is arranged as: WIRELESS-PROJECTOR-0010C626C0B1, wherein WIRELESS-PROJECTOR is a constant for identifying the device type as a wireless projector, 0010C626C0B1 is used for identifying the wireless projector, and “0010C626C0B1” is a 12-bit array defining one wireless projector device, different 12-bit arrays defining different projector devices.

Secondly, it is assumed that an office environment comprises a plurality of wireless computer networks. As shown in FIG. 2, the plurality of wireless computer networks are network 1, network 2 and network 3, wherein network 1 is connected via wireless access point (AP) mode; network 2 is connected via ad hoc (peer-to-peer) mode; network 3 is the wireless projector, and the SSID corresponding to network 3 is WIRELESS-PROJECTOR-0010C626C0B1.

Last, when the user terminal is entering this office network environment, it may obtain currently available three wireless networks (network 1, network 2 and network 3) by searching for this office network environment, and know that there is one wireless projector contained in network 3 according to the fact that the prefix part of the SSID corresponding to network 3 (i.e. WIRELESS-PROJECTOR-0010C626C0B1) matches the array WIRELESS-PROJECTOR corresponding to the projector type. The user terminal may select a wireless computer network to be accessed based on its own requirement. If the user terminal needs to use a wireless projector, it may select network 3 to access directly and use the wireless projector in network 3.

The above is only the preferred embodiments of the present invention and the present invention is not limited to the above embodiments. Therefore, any modifications, substitutions and improvements to the present invention are possible without departing from the spirit and scope of the present invention.

1. A method of discovering devices located in different wireless networks, a wireless network being built up for a device, wherein the wireless network is identified with a Service Set Identification (SSID) having an array for identifying device types, a correspondence between the array for identifying the device types and the device types being arranged at a user terminal, the method comprising steps of:
A. searching for a currently available wireless network by the user terminal in a wireless network environment in order to obtain an SSID corresponding to the currently available wireless network; and
B. determining a device type corresponding to an array owned by the obtained SSID according to the arranged correspondence, and displaying a device icon for the device type corresponding to the SSID, by the user terminal.

2. The method according to the claim 1, wherein when the user terminal discovers a device of the determined type, the step B of determining a device type corresponding to an array owned by the obtained SSID according to the arranged correspondence comprises steps of: B1. the user terminal determining an array corresponding to a type of the device to be discovered according to the arranged correspondence; judging whether the array corresponding to the type of the device to be discovered matches at least one of SSIDs obtained in the step A or not; and in a case of matching, determining that there is a device of the determined type to be discovered by the user terminal in the wireless network corresponding to the matched SSID.

3. The method according to the claim 1, wherein the array is a numeric string, a character string or a combination thereof.

4. The method according to the claim 1, wherein the SSID further comprises an array used for identifying devices.
